(19) United States
(12) Patent Application Publication
(10) Pub. No.: US 2012/0086714 A1
(43) Pub. Date: Apr. 12, 2012

(54) 3D IMAGE DISPLAY APPARATUS AND DISPLAY METHOD THEREOF

(75) Inventors: Su-jin YEON, Seoul (KR); Sang-il Lee, Suwon-si (KR); Hye-won Lee, Anyang-si (KR); Bo-mi Kim, Yongin-si (KR); Yeon-hee Lee, Seoul (KR); Moon-sik Jeong, Seongnam-si (KR)

(73) Assignee: Samsung Electronics Co., Ltd., Gyeonggi-do (KR)

(21) Appl. No.: 13/271,736

(22) Filed: Oct. 12, 2011

(30) Foreign Application Priority Data
Oct. 12, 2010 (KR) 10-2010-0099323
Jan. 5, 2011 (KR) 10-2010-0001127
Oct. 7, 2011 (KR) 10-2011-0102629

(51) Int. Cl. G06T 15/00

(52) U.S. Cl. 345/419

(57) ABSTRACT

A display method of a Three-Dimensional (3D) display apparatus is provided. The display method includes displaying a first display element having a first depth value; adjusting at least one depth value of the first display element and a second display element having a second depth value to be displayed in superimposition with or displayed on the first display element in a state where the first display element having the first depth value is displayed; and displaying the first display element and the second display element in superimposition with the first display element or on the first display element, of which the depth value has been adjusted, wherein at least one of the first display element and the second display element is displayed with an adjusted depth value. Accordingly, a user's attention and recognition can be heightened in executing the User Interface (UI).

### PRIORITY

This application claims priority under 35 U.S.C. §119(a) to Korean Patent Application Nos. 10-2010-0099323, 10-2011-0001127 and 10-2011-0102629, filed on Oct. 12, 2010, Jan. 5, 2011 and Oct. 7, 2011, respectively, in the Korean Intellectual Property Office, the entire disclosures of which are incorporated herein by reference.

### BACKGROUND OF THE INVENTION

1. Field of the Invention

The present invention relates to a Three-Dimensional (3D) 0 image display apparatus and a display method thereof, and more particularly to a 3D image display apparatus and a display method thereof, which can provide a 3D Graphical User Interface (GUI).

2. Description of the Related Art

3D stereoscopic image technology has very diverse application fields, such as information communication, broadcasting, medical treatment, educational training, military affairs, games, animation, virtual reality, Computer-Aided Design (CAD), industrial technology, and the like, and may be the core basic technology of the next-generation 3D stereoscopic multimedia information communication which is commonly required in these fields.

In general, a 3D effect occurs through complex actions of the degree of change in thickness of a crystalline lens according to the position of an object to be observed, a difference in angle between both eyes and an object, a difference in position and shape of an object between left and right eyes, disparity occurring in accordance with the movement of an object, and other effects caused by various kinds of psychologies and memories.

Among them, the binocular disparity that occurs due to a distance of about 6-7 cm between two human eyes may be the most important factor. Due to the binocular disparity, two eyes see the same object at different angles, and due to this difference in angle between the two eyes, different images are formed on the two eyes, respectively. These two images are transferred to viewer's brain through the retinas, and the brain accurately harmonizes these two kinds of information, resulting in that the viewer can feel the original 3D stereoscopic image.

A 3D image is composed of a left-eye image that is recognized by a left eye and a right-eye image that is recognized by a right eye. Also, the 3D display apparatus expresses a 3D effect of an image using the disparity between the left-eye image and the right-eye image. As described above, an environment in which a 3D image is implemented by alternately displaying the left-eye image and the right-eye image is called a stereo 3D image.

In order to express a 3D image in a Two-Dimensional (2D) image, methods for changing the transparency, performing a shading process, changing texture, and the like, have been used. However, in the case of using a 3D display apparatus, a 3D effect can be given even to a UI.

FIGS. 1A and 1B are diagrams explaining problems in the related art.

FIG. 1A shows a general 2D graphic (for example, 2.5D or 3D) User Interface (UI) screen, which expresses a difference in selection (attention) by giving variety to visual graphic elements, such as a position, size, color, and the like.

FIG. 1B shows a method of expressing a UI through stereo 3D, in which an object is expressed with a depth value in a Z-axis direction through utilization of a difference in visual point between both eyes that occurs when the object existing on the screen is seen in a method of expressing a UI through stereo 3D, and attention information between an element selected on the screen and the remaining elements is stereoscopically expressed through such a depth value.

As illustrated in FIG. 1B, in the case where UI elements having the same character are expressed in superimposition with each other on the screen where one or more UI elements having the depth values are stereoscopically reproduced using the stereo 3D, the depth values between the existing 3D UI elements and new UI elements, which exist on the screen, collide each other to cause the occurrence of visual interference.

Accordingly, since a distinction between the selected UI object and the unselected UI object becomes unclear on the screen, users are thrown into confusion in visibility or in UI operations, and excessive 3D values that are generated due to a plurality of UI elements shown on the screen may cause the users visual fatigue.

Additionally, when a 3D image is displayed on a background UI with depth, the 3D image may appear differently than how it should appear, or may cause visual fatigue to a user.

### SUMMARY OF THE INVENTION

The present invention has been made to address at least the above problems and/or disadvantages and to provide at least the advantages described below. Accordingly, an aspect of the present invention provides a 3D image display apparatus and a display method thereof, which can arrange and provide depth values among 3D display elements.

According to one aspect of the present invention, a display method of a 3D image display apparatus includes displaying a first display element having a first depth value; adjusting at least one depth value of the first display element and a second display element having a second depth value to be displayed in superimposition with or displayed on the first display element in a state where the first display element having the first depth value is displayed; and displaying the first display element and the second display element in superimposition with the first display element or on the first display element, of which the depth value has been adjusted, wherein at least one of the first display element and the second display element is displayed with an adjusted depth value.

According to another aspect of the present invention, a 3D image display apparatus includes a display processing unit for generating a first display element having a first depth value and a second display element having a second depth value; a display unit for displaying the generated first and second display elements; and a control unit for adjusting and displaying at least one depth value of the first display element and the second display element having the second depth value to be displayed in superimposition with or displayed on the first display element in a state where the first display element having the first depth value is displayed, wherein at least one of the first display element and the second display element is displayed with an adjusted depth value.

Accordingly, the display state of the 3D display elements can be visually stabilized, and a user's attention and recognition with respect to the 3D display elements can be heightened.

### BRIEF DESCRIPTION OF THE DRAWINGS

The above and other aspects, features and advantages of the present invention will be more apparent from the following detailed description when taken in conjunction with the accompanying drawings, in which:

FIGS. 1A and 1B are diagrams explaining problems in the related art;

FIG. 2 is a diagram illustrating a 3D image providing system according to an embodiment of the present invention;

FIG. 3 is a block diagram illustrating the configuration of a display apparatus according to an embodiment of the present invention;

FIG. 4A is a diagram illustrating the disparity between a left-eye image and a right-eye image according to an embodiment of the present invention;

FIG. 4B is a diagram illustrating the relationship between the disparity and the depth value according to an embodiment of the present invention;

FIGS. 5A to 5C are diagrams illustrating cases to which a display method according to an embodiment of the present invention is applied;

FIGS. 6A to 6C and 7A to 7C are diagrams illustrating a display method according to an embodiment of the present invention;

FIGS. 8A to 8C and 9A to 9C are diagrams illustrating a display method according to another embodiment of the present invention; and

FIG. 10 is a flowchart illustrating a display method of a 3D image display apparatus according to an embodiment of the present invention.

FIG. 11 is a diagram illustrating examples of a 3D image to which a display method according to an embodiment of the present invention is applied.

FIGS. 12A and 12B are diagrams illustrating a method of adjusting disparity information according to an embodiment of the present invention.

FIGS. 13A and 13B are flowcharts illustrating methods of adjusting depth according to embodiments of the present invention.

FIGS. 14A and 14B are diagrams illustrating methods of adjusting a set of left-eye and right-eye images and a reference surface in accordance with a previously-stored imaging distance according to embodiments of the present invention.

FIGS. 15A to 15C are diagrams illustrating examples to which methods of adjusting depth according to embodiments of the present invention are applied.

FIGS. 16A to 16C are diagrams illustrating other examples to which methods of adjusting depth according to embodiments of the present invention are applied.

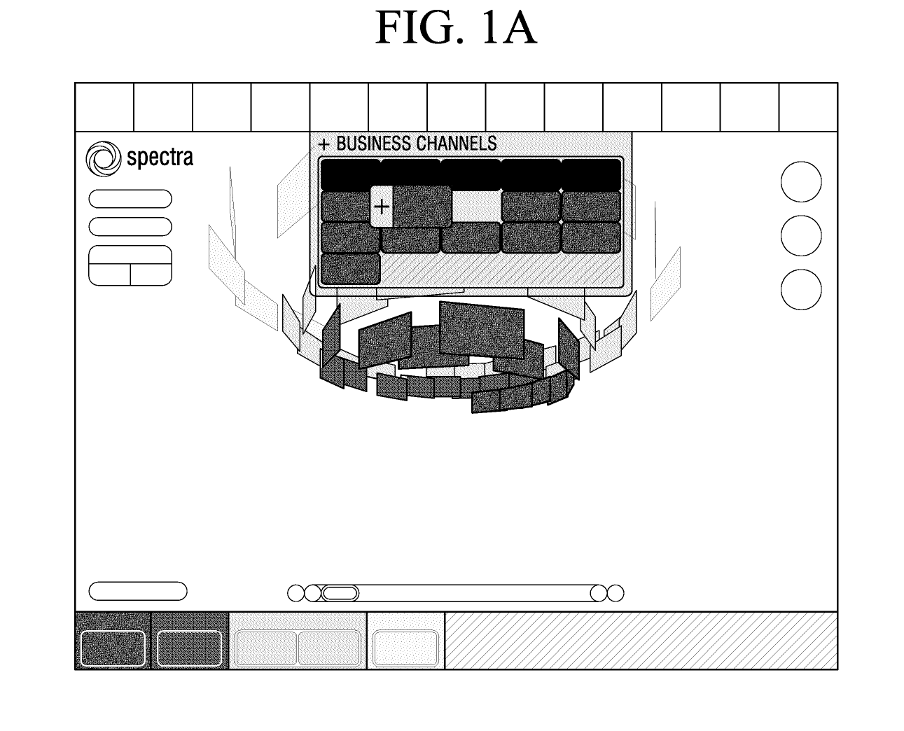

### DETAILED DESCRIPTION OF EMBODIMENTS OF THE PRESENT INVENTION

Hereinafter, preferred embodiments of the present invention are described in detail with reference to the accompanying drawings. For reference, in explaining the present invention, well-known functions or constructions will not be described in detail so as to avoid obscuring the description with unnecessary detail.

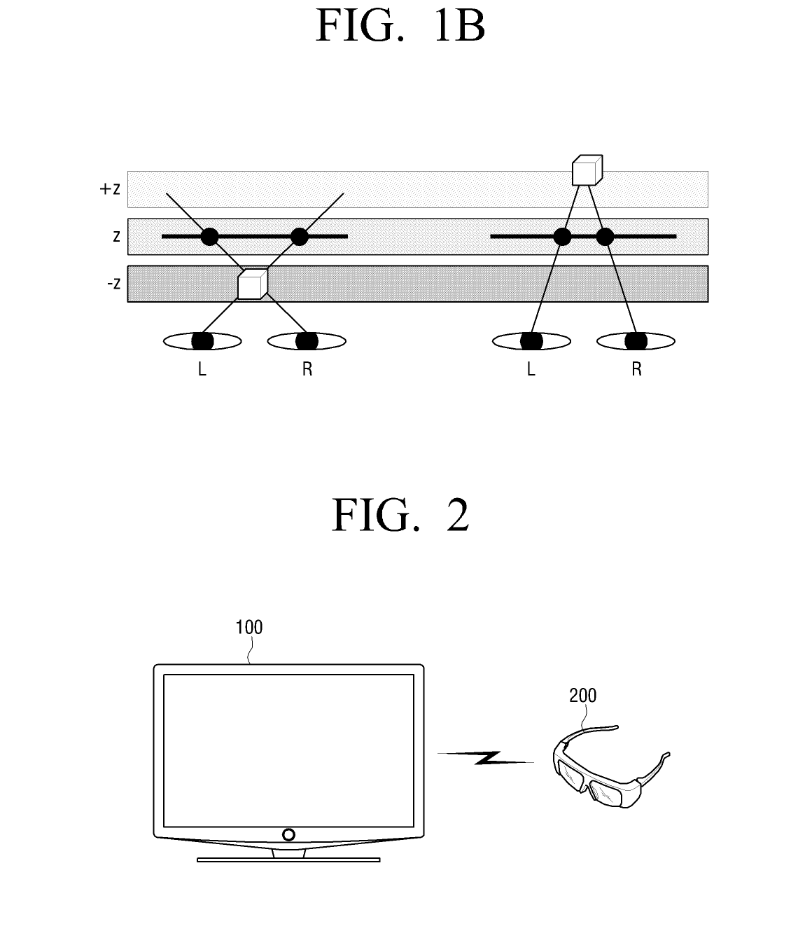

FIG. 2 is a diagram illustrating a 3D image providing system according to an embodiment of the present invention. As illustrated in FIG. 2, the 3D image providing system includes a display apparatus 100 for displaying a 3D image on a display and 3D glasses 200 for viewing the 3D image.

The 3D image display apparatus 100 may be implemented to display a 3D image or to display both a 2D image and a 3D image.

In the case where the 3D image display apparatus 100 displays a 2D image, the same method as the existing 2D display apparatus may be used, while in the case where the 3D image display apparatus 100 displays a 3D image, the received 2D image may be converted into a 3D image and the converted 3D image may be displayed on the screen. According to circumstances, a 3D image that is received from an imaging device such as a camera or a 3D image that is captured by a camera, edited/processed in a broadcasting station, and transmitted from the broadcasting station may be received and processed to be displayed on the screen.

In particular, the 3D image display apparatus 100 can process a left-eye image and a right-eye image with reference to the format of the 3D image, and make the processed left-eye image and right-eye image be time-divided and alternately displayed. A user can view the 3D image through alternate seeing of the left-eye image and the right-eye image that are displayed on the display apparatus 100 with the left eye and the right eye using the 3D glasses 200.

In general, since the left eye and the right eye of an observer observe one 3D object in minutely different positions, the observer recognizes minutely different image information through the left eye and the right eye. The observer acquires depth information on the 3D object by combining the minutely different image information, and feels the 3D effect.

The 3D image display apparatus 100 according to the present invention enables the observer to feel the 3D image by providing images that the left eye and the right eye of the observer can see to the observer when the observer actually observes the 3D object. In this case, a difference in images that the left eye and the right eye of the observer see is called disparity. If such disparity has a positive value, the observer feels as if the 3D object is positioned closer to a predetermined reference surface in a direction of the observer, and if the disparity has a negative value, the observer feels as if the 3D object is spaced apart in an opposite direction to the observer.

The 3D glasses 200 may be implemented by active type shutter glasses. The shutter glass type corresponds to a display method using the disparity of both eyes, which enables the observer to recognize space feeling caused by a brain action from the image that is observed at different angles through synchronization of the image providing of the display apparatus with the on/off operation of both left and right eyes of the 3D glasses.

The principle of the shutter glass type is to synchronize left and right image frames that are reproduced in the 3D image display apparatus 100 with a shutter mounted on the 3D glasses 200. That is, as left and right glasses of the 3D glasses are selectively opened and closed according to left and right image sync signals of the 3D image display apparatus 100, the 3D stereoscopic image is provided.

On the other hand, the 3D image display apparatus 100 can display a 3D display element, for example, a 3D UI (particularly, a GUI) on the screen together with the 3D image. Here, the GUI is means for inputting a user command through selection of an icon or menu that is displayed on the display. For example, the user may move a cursor with reference to a menu, a list, an icon, and the like, which are displayed on the display through the GUI, and select an item on which the cursor is located.

Since the 3D image display apparatus 100 can implement a 3D image through adjustment of only the disparity between a left-eye image and a right-eye image for the 3D effect, it can provide the 3D GUI without the necessity of passing through separate image processing (scaling, texture, and perspective effect processing).

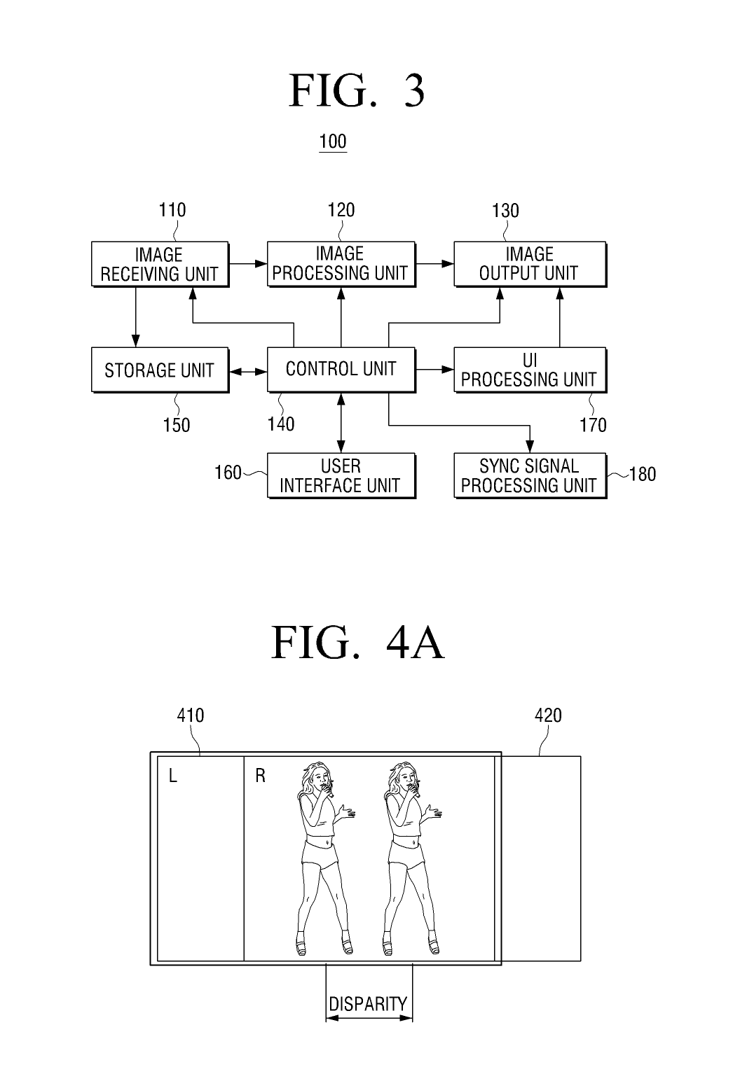

FIG. 3 is a block diagram illustrating the configuration of a display apparatus according to an embodiment of the present invention.

Referring to FIG. 3, the 3D image display apparatus 100 according to an embodiment of the present invention includes an image receiving unit 110, an image processing unit 120, a display unit 130, a control unit 140, a storage unit 150, a user interface unit 160, a UI processing unit 170, and a sync signal processing unit 180.

On the other hand, although FIG. 2 illustrates that the 3D image display apparatus 100 is a 3D TeleVision (TV), this is merely exemplary, and the 3D image display apparatus 100 according to an embodiment of the present invention may be implemented by all devices that can display 3D UI elements, such as a digital TV, a mobile communication terminal, a mobile telephone, a Personal Digital Assistant (PDA), a smart phone, a Digital Multimedia Broadcasting (DMB) phone, an MPEG Audio Layer III (MP3) player, an audio appliance, a portable TV, and a digital camera.

The image receiving unit 110 receives and demodulates a 2D or 3D image signal that is received by wire or wirelessly from a broadcasting station or a satellite. Further, the image receiving unit 110 may be connected to an external appliance such as a camera to receive a 3D image from the external appliance. The external appliance may be connected wirelessly or by wire through an interface such as S-Video, component, composite, D-Sub, Digital Visual Interface (DVI), and High-Definition Multimedia Interface (HDMI). Since a 2D image processing method is well known to those skilled in the art, explanation will be hereinafter made around a 3D image processing method.

As described above, a 3D image is an image composed of at least one frame. One frame may include a left-eye image and a right-eye image, or each frame may be composed of a left-eye frame or a right-eye frame. That is, a 3D image is an image that is generated according to one of diverse 3D formats.

Accordingly, the 3D image received in the image receiving unit 110 may be in diverse formats, and particularly may be in a format according to one of a general top-bottom type, a side-by-side type, a horizontal interleave type, a vertical interleave type or checker board type, and a sequential frame.

The image receiving unit 110 transfers the received 2D image or 3D image to the image processing unit 120.

The image processing unit 120 performs signal processing, such as video decoding, format analysis, and video scaling, and a task of GUI addition and the like, with respect to the 2D image or 3D image that is received in the image receiving unit 110.

In particular, the image processing unit 120 generates a left-eye image and a right-eye image, which correspond to the size of one screen (for example, 1920*1080) using the format of the 2D image or 3D image that is input to the image receiving unit 110.

For example, if the format of the 3D image is a format according to the top-bottom type, the side-by-side type, the horizontal interleave type, the vertical interleave type or checker board type, or the sequential frame, the image processing unit 120 generates the left-eye image and right-eye image to be provided to the user by extracting a left-eye image portion and a right-eye image portion from each image frame and performing expansion scaling or interpolation of the extracted left-eye image and right-eye image.

Further, if the format of the 3D image is of a general frame sequence type, the image processing unit 220 extracts the left-eye image or the right-eye image from each frame and prepares to provide the extracted image to the user.

On the other hand, information on the format of the input 3D image may be included in the 3D image signal or may not be included therein.

For example, if the information on the format of the input 3D image is included in the 3D image signal, the image processing unit 120 extracts the information on the format by analyzing the 3D image, and processes the received 3D image according to the extracted information. By contrast, if the information on the format of the input 3D image is not included in the 3D image signal, the image processing unit 120 processes the received 3D image according to the format input from the user, or processes the received 3D image according to a preset format.

The image processing unit 120 performs time division of the extracted left-eye image and right-eye image and alternately transfers the time-divided left-eye image and right-eye image to the display unit 130. That is, the image processing unit 120 transfers the left-eye image and the right-eye image to the display unit 130 in the temporal order of “left-eye image (L1)→right-eye image (R1)→left-eye image (L2)→right-eye image (R2)→ . . . ”.

Further, the image processing unit 120 may insert an On-Screen Display (OSD) image generated by an OSD processing unit 150 into a black image, or process and provide the OSD image itself as one image.

The display unit 130 alternately outputs the left-eye image and the right-eye image output from the image processing unit 120 to the user.

The control unit 140 controls the whole operation of the display apparatus 100 according to a user command transferred from the user interface unit 170 or a preset option.

In particular, the control unit 140 controls the image receiving unit 110 and the image processing unit 120 to receive the 3D image, separate the received 3D image into a left-eye image and a right-eye image, and perform scaling or interpolation of the separated left-eye image and right-eye image with a size in which the separated left-eye image and right-eye image can be displayed on one screen.

Further, the control unit 140 controls the display unit 130 to be switched so that the polarization direction of the image that is provided through the display unit 130 coincides with the left-eye image or the right-eye image.

Further, the control unit 140 may control the operation of the UI processing unit 170 to be described later.

The UI processing unit 150 may generate a display element that is displayed to overlap the 2D or 3D image output to the display unit 130, and insert the generated display element into the 3D image.

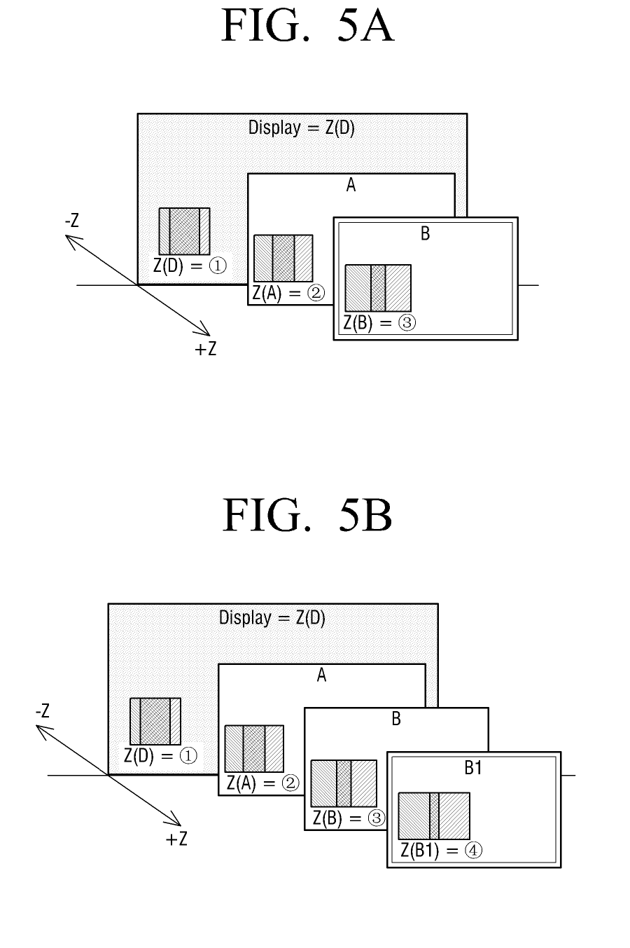

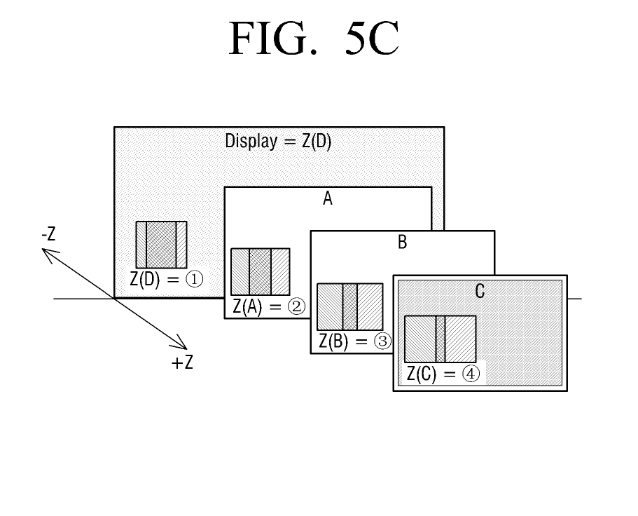

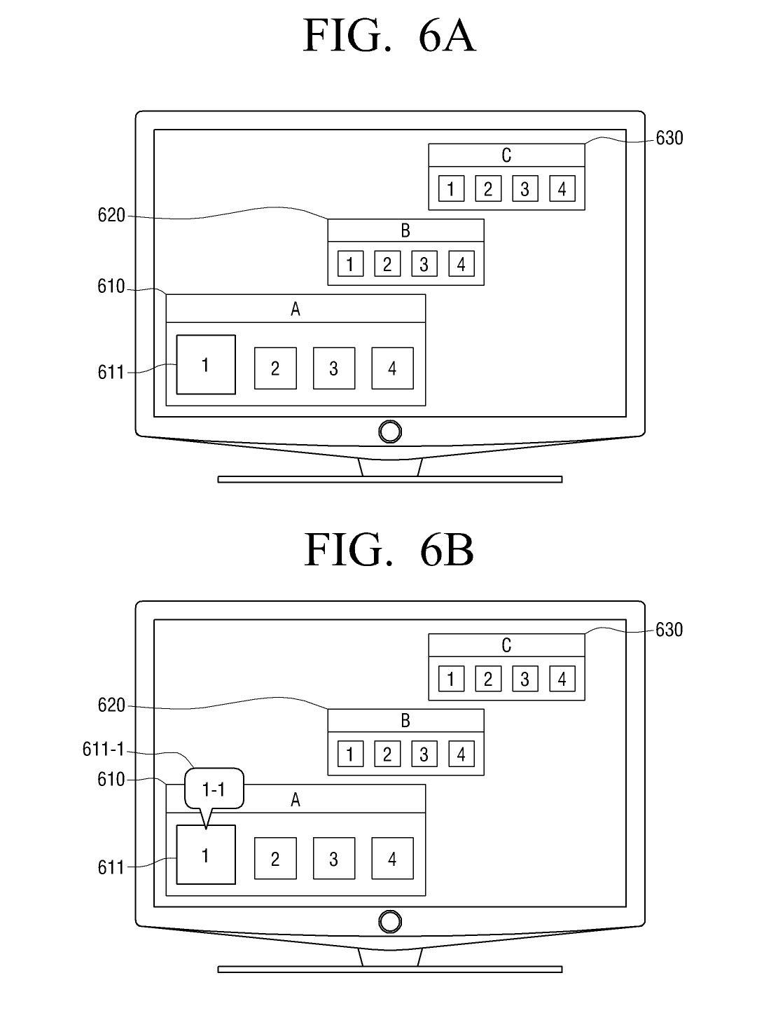

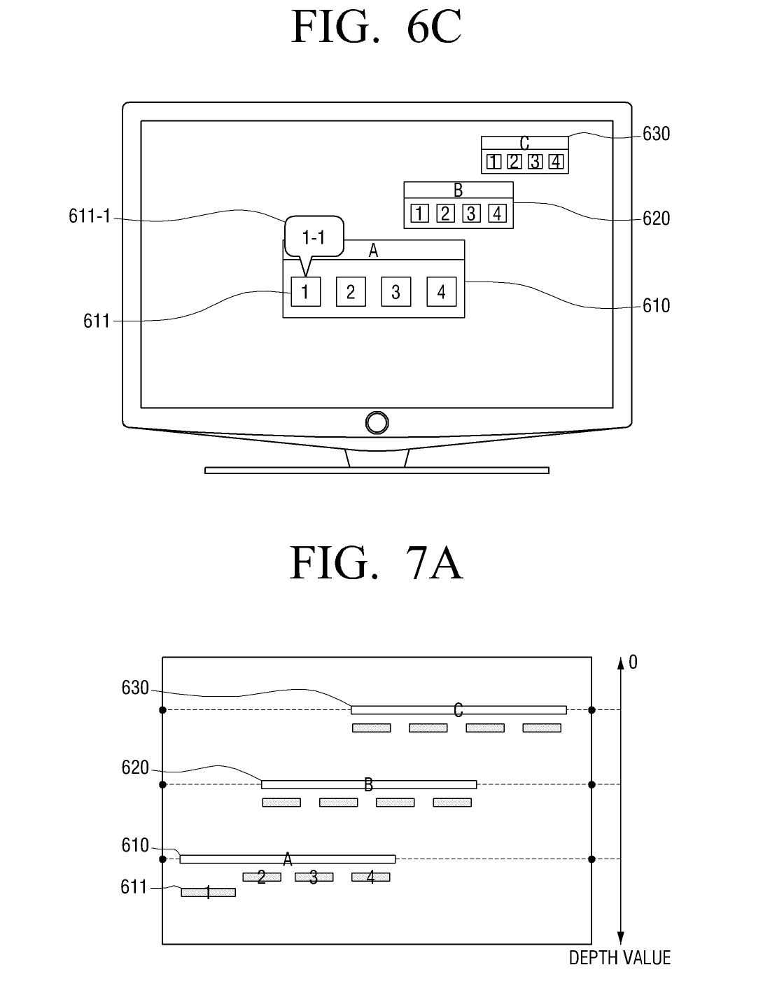

Further, the UI processing unit 150 may set and generate depth values that are different according to the execution order of display elements such as, for example, UI elements, attributes thereof, and the like. Here, the depth value means a numerical value that indicates the degree of depth feeling in the 3D image. The 3D image can express the depth feeling that corresponds to not only the positions in up, down, left, and right direction on the screen but also the positions in forward and backward directions that are viewer's eye directions. In this case, the depth feeling is determined by the disparity between the left-eye image and the right-eye image. Accordingly, the depth value of the 3D content list GUI corresponds to the disparity between the left-eye GUI and the right-eye GUI. The relationship between the depth value and the disparity will be described in more detail with reference to FIGS. 5 and 6 later.

Here, the UI elements may be displayed to overlap the display image as a screen that displays characters or figures of a menu screen, caution expression, time, and channel number on the display screen.

For example, a caution expression may be displayed as a UI element in an OSD form according to a preset option or event.

On the other hand, as a user operates input devices such as an operation panel and a remote controller in order to select a desired function from the menus, a main menu, a sub-menu, and the like, may be displayed on the display screen as UI elements in an OSD form.

Such menus may include option items that can be selected in the display apparatus or items that can adjust the function of the display apparatus.

Further, the UI processing unit 150 may perform tasks of 2D/3D conversion of UI elements, transparency, color, size, shape and position adjustment, highlight, animation effect, and the like, under the control of the control unit 140.

The control unit 140 may calculate a value of the relative depth of a second display element to a first display element, may detect a set of left-eye and right-eye images that correspond to the calculated relative depth value from among a plurality of sets of previously-stored left-eye and right-eye images that correspond to different depth values, and may replace the left-eye and right-eye images of the second display element with the detected set of left-eye and right-eye images.

Further, the control unit 140 may replace one of the left-eye and right-eye images of the second display element with another image.

Further, the control unit 140 may adjust the distance, on a screen, between the left-eye and right-eye images of the second display element in accordance with the distance between the left-eye and right-eye images of the first display element, and may display the distance-adjusted left-eye and right-eye images.

The first display element may be a background element, and the second display element may be a content element on the background element.

The storage unit 160 is a storage medium in which various kinds of programs which are required to operate the 3D image display apparatus 100 are stored, and may be implemented by a memory, an Hard Disk Drive (HDD), and the like. For example, the storage unit may include a Read-Only Memory (ROM) for storing programs for performing the operation of the control unit 140, a Random Access Memory (RAM) for temporarily storing data according to the operation performance of the control unit 140, and the like. The storage unit 160 may further include an Electrically Erasable and Programmable ROM (EEPROM) for storing various kinds of reference data.

The user interface unit 170 transfers a user command that is received from input means such as a remote controller, an input panel, or the like, to the control unit 140.

Here, the input panel may be a touch pad, a key pad that is composed of various kinds of function keys, numeral keys, special keys, character keys, and the like, or a touch screen.

The sync signal processing unit 180 generates a sync signal for alternately opening the left-eye shutter glass and the right-eye shutter glass of the 3D glasses 200 to match the display timing of the left-eye image and the right-eye image, and transmits the sync signal to the 3D glasses 200. Accordingly, the 3D glasses 200 are alternately opened and closed, so that the left-eye image is displayed on the display unit 130 in the left-eye open timing of the 3D glasses 200 and the right-eye image is displayed on the display unit 130 in the right-eye open timing of the 3D glasses 200. Here, the sync signal may be transmitted in the form of infrared rays.

The control unit 140 controls the whole operation of the 3D image display apparatus 100 according to a user operation that is transferred from the user interface unit 170.

In particular, the control unit 140 controls the image receiving unit 110 and the image processing unit 120 to receive the 3D image, separate the received 3D image into a left-eye image and a right-eye image, and perform scaling or interpolation of the separated left-eye image and right-eye image with a size in which the separated left-eye image and right-eye image can be displayed on one screen.

Further, the control unit 140 controls the OSD processing unit 150 to generate an OSD that corresponds to the user operation that is transferred from the user interface unit 170, and controls the sync signal processing unit to generate and transmit the sync signal that is synchronized with the output timing of the left-eye image and the right-eye image.

Further, if a second UI element having a second depth value is executed to be displayed in superimposition with a first UI element in a state where the first UI element having a first depth value is displayed, the control unit 140 can operate to adjust at least one depth value of the first UI element and the second UI element using the depth value of the first UI element.

Specifically, the control unit 140 can adjust a difference in depth values between the first UI element and the second UI element in consideration of the respective depth values of the first UI element and the second UI element.

Specifically, the control unit 140 can change the second depth value of the second UI element to a preset depth value, and then change the first depth value of the first UI element as large as the depth value to which the second UI element has been changed. Here, the preset depth value may be a value that is smaller than the second depth value. Further, the preset depth value may include a depth value of a display screen.

Further, if a new UI element is executed to be displayed in superimposition with a plurality of UI elements in a state where the plurality of UI elements having the corresponding depth values have been executed to be displayed, the control unit 140 can adjust the depth values of the plurality of UI elements which have been executed to be displayed to the same depth value. Here, the adjusted depth value may be smaller than the depth value of the newly executed UI element.

Further, the control unit 140 can adjust the adjusted depth value of the first and second UI elements to the original depth values if the execution of the superimposition display of the first and second UI elements is canceled.

On the other hand, the UI that is executed to be displayed in superimposition with the UI element which has been executed to be displayed may be a UI element having a feedback property that includes event contents related to the already executed UI element, or a UI element having at least one property of alarm, caution, and popup that include event contents which are not related to the already executed UI element.

The 3D glasses 200 enables a user to view the left-eye image and the right-eye image through the left eye and the right eye, respectively, by alternately opening and closing the left-eye shutter glass and the right-eye shutter glass according to the sync signal received from the 3D image display apparatus 100.

On the other hand, the display unit 130 may include detailed configurations, such as a panel driving unit (not illustrated), a display panel unit (not illustrated), a backlight driving unit (not illustrated), and a backlight emitting unit (not illustrated), and the detailed explanation thereof will be omitted.

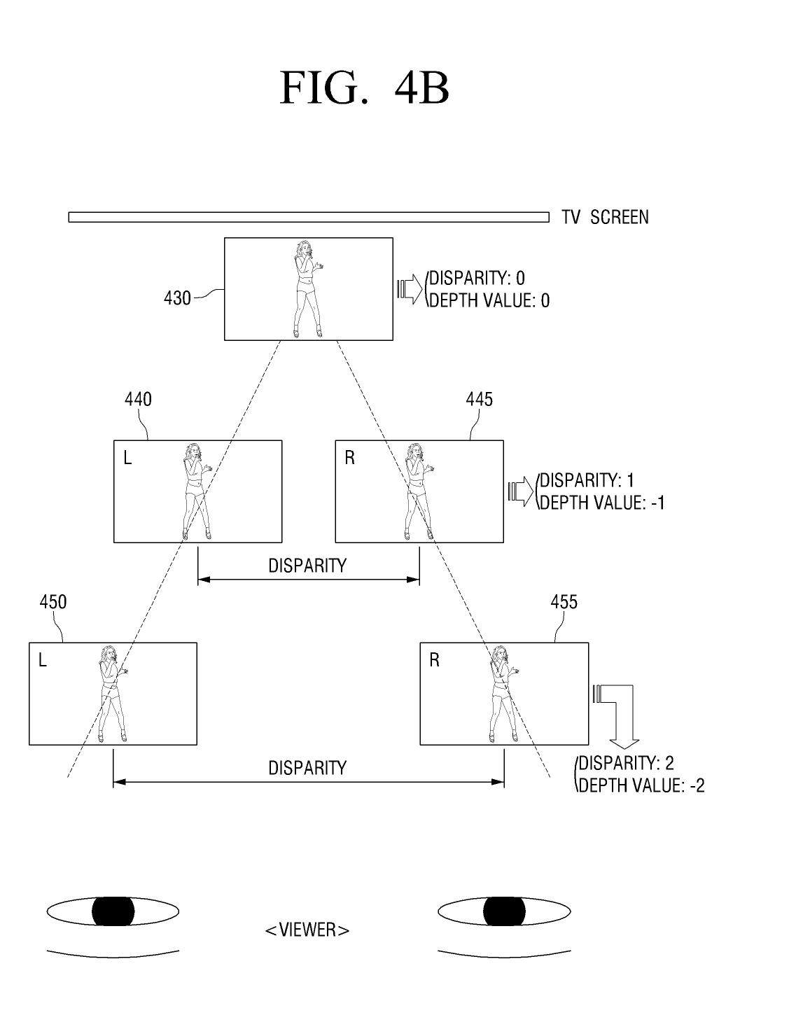

In this case, the depth value is determined by the disparity between the left-eye image and the right-eye image, and this will now be described in detail with reference to FIGS. 4A and 4B.

FIG. 4A is a diagram illustrating the disparity between the left-eye image and the right-eye image according to an embodiment of the present invention.

FIG. 4A illustrates that an object 410 of the left-eye image and an object 420 of the right-eye image overlap each other. However, in the case of an actual display on the screen, the object 410 of the left-eye image and the object 420 of the right-eye image are alternately displayed.

As illustrated in FIG. 4A, the degree of mismatch between the object 410 of the left-eye image and the object 420 of the right-eye image is called the disparity.

FIG. 4B illustrates the relationship between the disparity and the depth value according to an embodiment of the present invention.

FIG. 4B illustrates the disparity that occurs between a TV screen and user's eyes. User's eyes have the disparity according to the distance between the two eyes.

Further, as illustrated in FIG. 4B, it can be confirmed that an object that is closer to the user has a larger disparity. Specifically, in the case of displaying an object that is positioned on the surface (that is, the depth value is “0”) of the TV screen, the left-eye image and the right-eye image are displayed in one position without the disparity. By contrast, in the case of displaying an object in a position which is somewhat closer to the viewer and thus has a depth value of “−1”, it is required that the left-eye image 440 and the right-eye image 445 are displayed in positions which are spaced apart for the disparity of “1” from each other. Further, in the case of displaying an object in a position which is further closer to the viewer and thus has a depth value of “−2”, it is required that the left-eye image 440 and the right-eye image are displayed in positions which are spaced apart for the disparity of “2” from each other.

As described above, it can be confirmed that the depth value is a value that corresponds to the disparity. Accordingly, the 3D TV 100 can set the depth value of the 3D GUI using the disparity between the left-eye GUI and the right-eye GUI without separate image processing.

Hereinafter, with reference to FIGS. 5A to 9C, a method of adjusting a depth value of a UI element will be described. Although FIGS. 5A to 9C illustrate a UI in a 2D state, it is to be noted that they actually indicate a stereo 3D GUI that is implemented by alternately displaying a left-eye GUI and a right-eye GUI.

FIGS. 5A to 5C are diagrams illustrating cases to which a display method according to an embodiment of the present invention is applied.

As illustrated in FIG. 5A, on a screen where a stereo 3D can be reproduced, UIs “A” and “B” are positioned with depth values which are equal to or at least larger than that of the display screen in the Z-axis direction through the pixel disparity. Specifically, a left-eye image that is projected from a left-eye pixel is formed as an image having a predetermined disparity from a right-eye image, and the right-eye image that is projected from a right-eye pixel is formed as an image having a predetermined disparity from the left-eye image. Accordingly, when the left eye and the right eye of an observer recognize the left-eye image that is projected from the left-eye pixel and the right-eye image that is projected from the right-eye pixel, the observer can feel the 3D effect through obtaining of the same depth information as that in the case where the observer sees the actual 3D object through the left eye and the right eye.

In this case, since the currently selected UI “B” is executed later than the UI “A”, it may be positioned at an upper end of the display screen.

Thereafter, as illustrated in FIG. 5B, a UI “B1” that is executed by a user's input on the selected UI “B” may be positioned at the upper end of the display screen with a depth value that is larger than that of the UI “A” or “B” in the Z-axis direction. Here, the UI “B1” is a kind of UI event that is related to the UI “B”, and may be a UI element having the character such as a feedback as a result of execution according to the user's input.

Further, as illustrated in FIG. 5C, an additionally executed UI “C” may be positioned at the upper end of the display screen with a depth value that is larger than that of the UI “A” or “B” in the Z-axis direction. Here, the UI “C” may be a new UI element that is executed through generation of an new window such as an alarm or caution message window or a popup form as a separate UI event that is not related to the UI “A” or “B”.

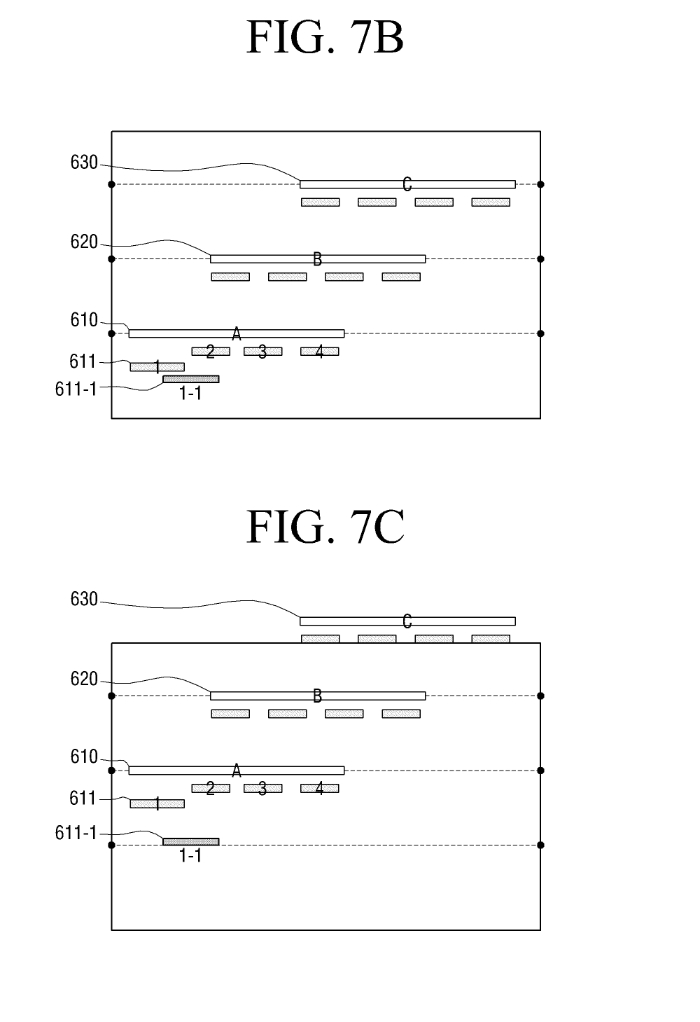

FIGS. 6A to 6C and 7A to 7C are diagrams illustrating a display method according to an embodiment of the present invention.

FIGS. 6A to 6C and 7A to 7C are related to a display method in the case where the UI execution screen is changed from the UI execution screen as illustrated in FIG. 5A to the UI execution screen as illustrated in FIG. 5B.

Here, FIGS. 6A to 6C illustrate front views of a stereo 3D screen, and FIGS. 7A to 7C illustrate top views. The state illustrated in FIGS. 6A to 6C corresponds to the UI execution state illustrated in FIGS. 7A to 7C.

As illustrated in FIG. 6A, on a screen where UI elements A, B, and C 610, 620, and 630 having different depth values are executed, a UI element 1-1 611-1 having a predetermined depth value as illustrated in FIG. 6B may be executed in superimposition according to a user's command or a preset option. Now, a case where the UI element 1-1 611-1 executed in superimposition is a UI element that is related to the already executed UI element A (for example, a UI element having the feedback characteristic to the UI element A-1 611) will be described as an example.

When the UI element 1-1 611-1 having a predetermined depth value is executed in superimposition as illustrated in FIG. 6B, the depth values of the already executed UI elements A, B, and C and the UI element 1-1 611-1 to be newly executed may be adjusted and displayed as illustrated in FIG. 6C.

A detailed method of adjusting the depth value of the newly executed UI element 1-1 611-1 will be described with reference to FIGS. 7A to 7C.

Respective UI elements illustrated in FIG. 7A correspond to respective UI elements illustrated in FIG. 6A, and it can be confirmed that the illustrated UI element A 610 (in particular, UI element A-1 611) is being executed.

Respective UI elements illustrated in FIG. 7B correspond to respective UI elements illustrated in FIG. 6B, and it can be confirmed that the illustrated UI element 1-1 611-1 having a predetermined depth value is being executed in superimposition with the UI element A-1 611.

Respective UI elements illustrated in FIG. 7C correspond to respective UI elements illustrated in FIG. 6C, and the illustrated UI element 1-1 611-1 executed in superimposition can be moved as large as a predetermined depth value Z(*), and then the already executed UI elements can be moved as large as the depth value for which the UI element 1-1 611-1 has been moved, that is, Z(1-1)-Z(*).

Even in this case, the UI element 1-1 611-1 that is lastly input by the user maintains the character having the depth value at the uppermost end of the current display screen.

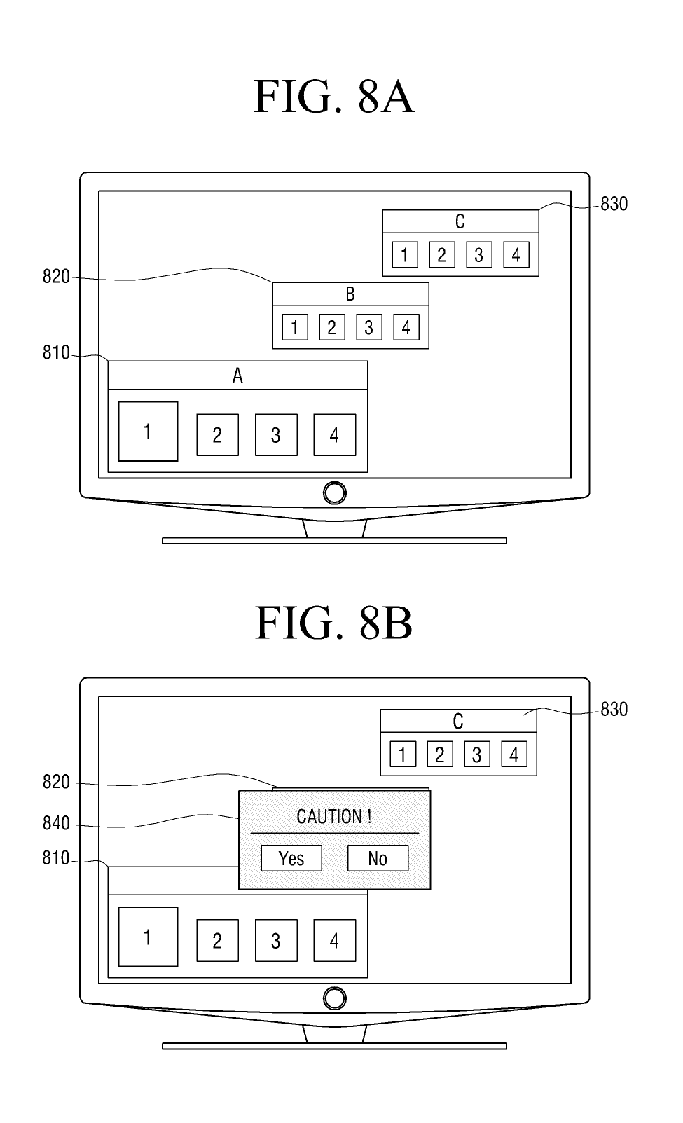

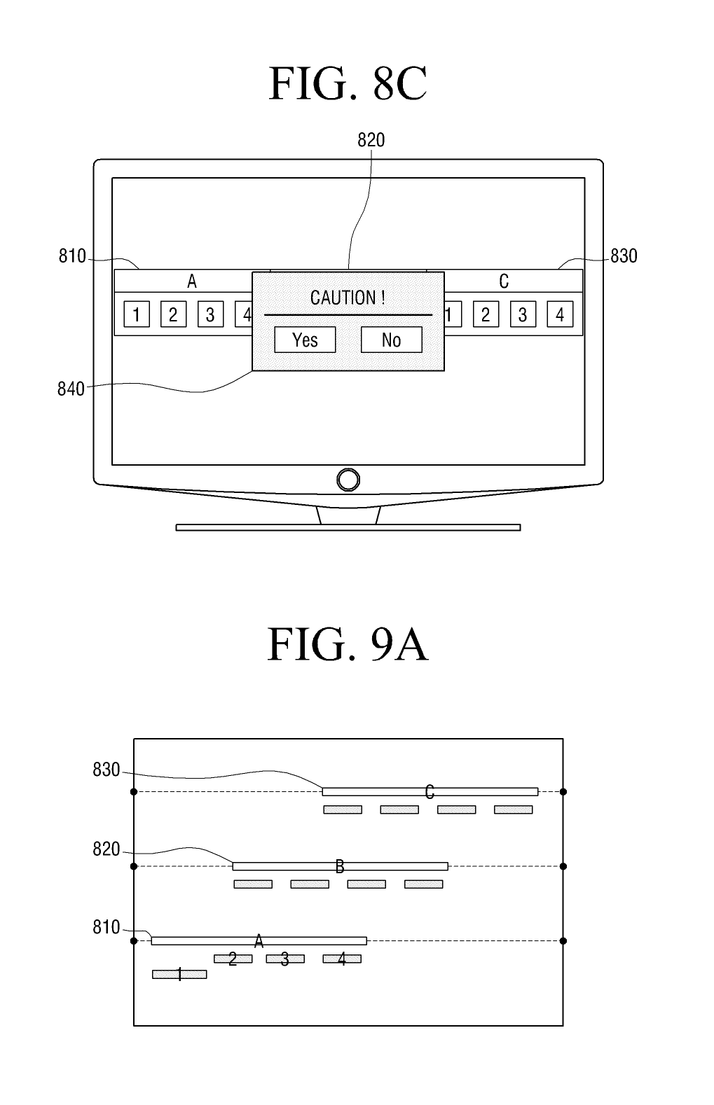

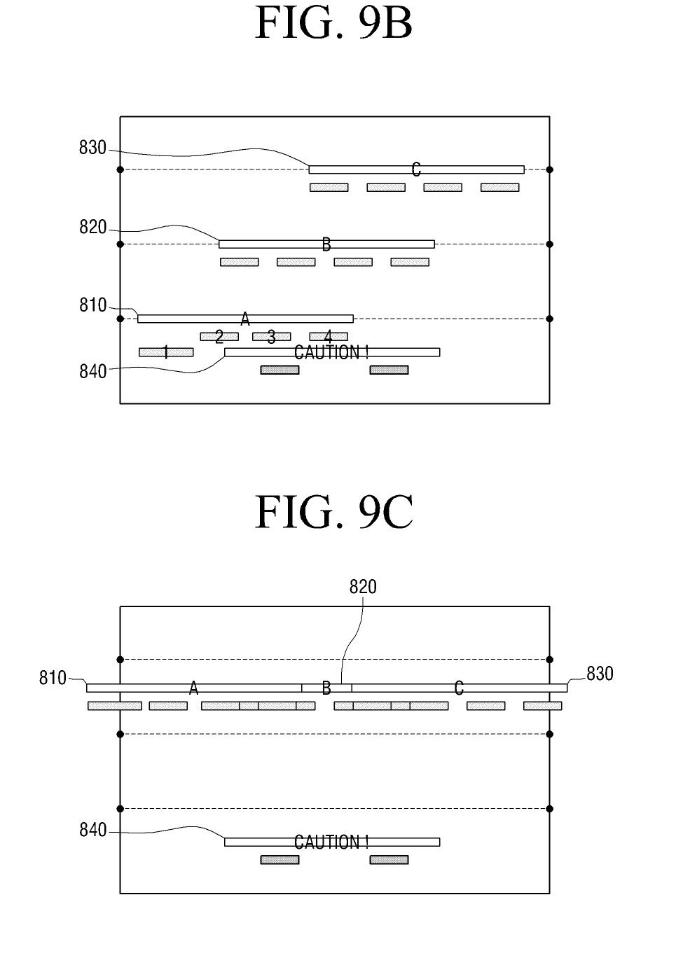

FIGS. 8A to 8C and 9A to 9C are diagrams illustrating a display method of according to another embodiment of the present invention.

FIGS. 8A to 8C and 9A to 9C are related to the display method in the case where the UI execution display screen is changed from the UI execution display screen as illustrated in FIG. 5A to the UI execution display screen as illustrated in FIG. 5C.

Here, FIGS. 8A to 8C illustrate front views of a stereo 3D screen, and FIGS. 9A to 9C illustrate top views. The state illustrated in FIGS. 8A to 8C corresponds to the UI execution state illustrated in FIGS. 9A to 9C.

As illustrated in FIG. 8A, on a screen where UI elements A, B, and C 810, 820, and 830 having different depth values are executed, a UI element 840 having a predetermined depth value as illustrated in FIG. 8B may be executed in superimposition according to a user's command or a preset option. Now, a case where the UI element 840 executed in superimposition is a UI element that is not related to the already executed UI elements A, B, and C 810, 820, and 830 will be described as an example. For example, a UI element D may be a new UI element that is executed through generation of an new window such as an alarm or caution message window or a popup form as a separate UI event that is not related to the already executed UI elements A, B, and C.

In the case where the UI element 840 having a predetermined depth value is executed in superimposition as illustrated in FIG. 8B, the depth values of the already executed UI elements A, B, and C 810, 820, and 830 and the UI element 840 to be newly executed may be adjusted and displayed as illustrated in FIG. 8C.

A detailed method of adjusting the depth value of the newly executed UI element 840 will be described with reference to FIGS. 9A to 9C.

Respective UI elements illustrated in FIG. 9A correspond to respective UI elements illustrated in FIG. 8A, and it can be confirmed that the illustrated UI element A 810 is being executed.

Respective UI elements illustrated in FIG. 9B correspond to respective UI elements illustrated in FIG. 8B, and it can be confirmed that the illustrated UI element 840 having a predetermined depth value is being executed in superimposition with the UI elements A, B, and C 810, 820, and 830.

Respective UI elements illustrated in FIG. 9C correspond to respective UI elements illustrated in FIG. 8C, and the already executed UI elements A, B, and C 810, 820, and 830 except for the illustrated UI element 840 executed in superimposition can be moved with the same depth value Z(#).

Even in this case, the UI elements A, B, and C 810, 820, and 830 which are merged with the same depth value Z(#) maintain the 3D UI character having the predetermined depth value except for the case where Z(#) is “0”.

On the other hand, in the embodiments illustrated in FIGS. 6A to 9C, a case where the UI elements are executed in superimposition in +Z-axis direction is exemplified for convenience in explanation. However, this is merely exemplary, and the same principle can be applied in the case where the UI elements are executed in −Z-axis direction and in the case where the UI elements are mixedly executed in +Z-axis direction and in −Z-axis direction.

Further, in the embodiments illustrated in FIGS. 6A to 9C, it is exemplified that the depth value is adjusted in the method as illustrated in FIGS. 6A to 7C in the case of the UI that is related to the currently executed UI element, while the depth value is adjusted in the method as illustrated in FIGS. 8A to 9C in the case of the UI that is not related to the currently executed UI element. However, this is merely exemplary, and it is possible to apply the display method as illustrated in FIGS. 6A to 7C and the display method as illustrated in FIGS. 8A to 9C regardless of the character of the UI element.

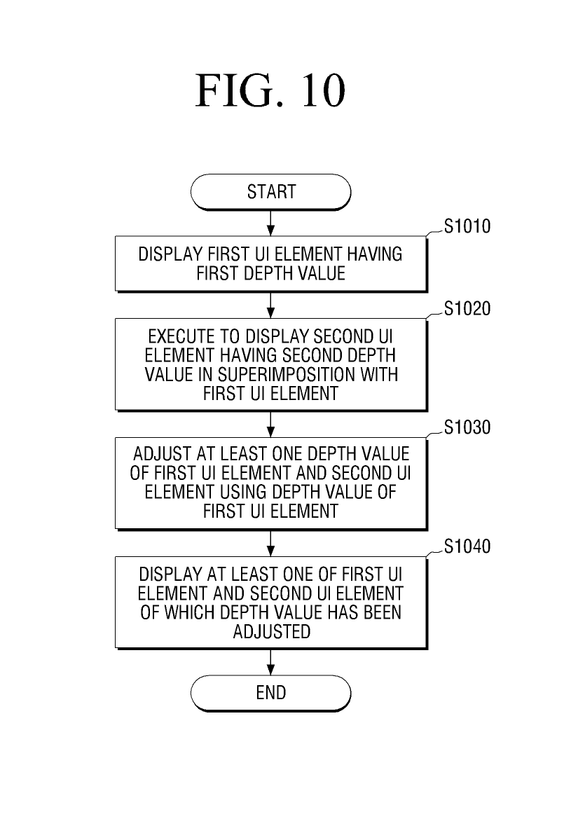

FIG. 10 is a flowchart illustrating a display method of a 3D image display apparatus according to an embodiment of the present invention.

Referring to FIG. 10, according to the display method of the 3D image display apparatus, a first UI element having a first depth value is displayed (S1010), and a second UI element having a second depth value is executed to be displayed in superimposition with the first UI element (S1020). Here, the depth value may correspond to the disparity between the left-eye UI and the right-eye UI.

Then, at least one depth value of the first UI element and the second UI element is adjusted using the depth value of the first UI element (S1030).

Thereafter, at least one of the first UI element and the second UI element, of which the depth value has been adjusted in step S1030, is displayed (S10400).

Here, in step S1030, the different in depth values between the first UI element and the second UI element can be adjusted in consideration of the respective depth values of the first UI element and the second UI element.

Further, in step S1030, the second depth value of the second UI element can be changed to a preset depth value, and then the first depth value of the first UI element can be changed as large as the depth value to which the second UI element has been changed.

Here, the preset depth value may be a value that is smaller than the second depth value of the second UI element.

Further, the preset depth value may include the depth value of the display screen.

Further, a third UI element having a third depth value may be displayed before execution of the second UI element. In this case, the depth value-adjusting step may adjust the first and third depth values of the first and third UI elements to the same depth value if the second UI element having the second depth value is executed to be displayed in superimposition with the first UI element and the third UI element.

Here, the adjusted same depth value of the first and third UI elements may be a value that is smaller than the second depth value of the second UI element.

Further, the adjusted depth value of the first and second UI elements can be adjusted to the original depth values if the execution of the superimposition display of the first and second UI elements is canceled.

On the other hand, the second UI element may be a UI element having a feedback property that includes event contents related to the first UI element, and a UI element having at least one property of alarm, caution, and popup that include event contents which are not related to the first UI element.

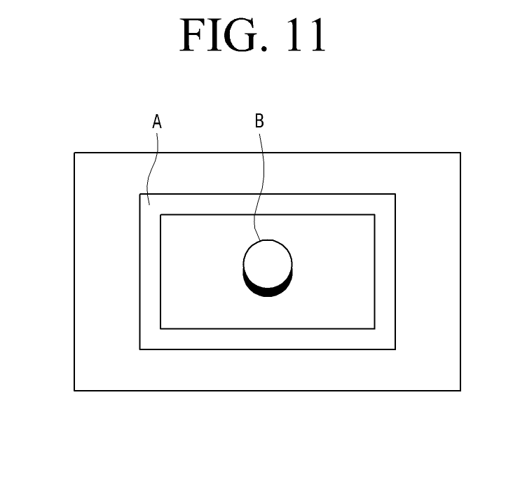

FIG. 11 is a diagram illustrating an example of a 3D image to which a display method according to an embodiment of the present invention is applied.

Referring to FIG. 11, a display method according to an embodiment of the present invention may be applied when content B with depth or a 3D image including content B is displayed over a background UI A with depth.

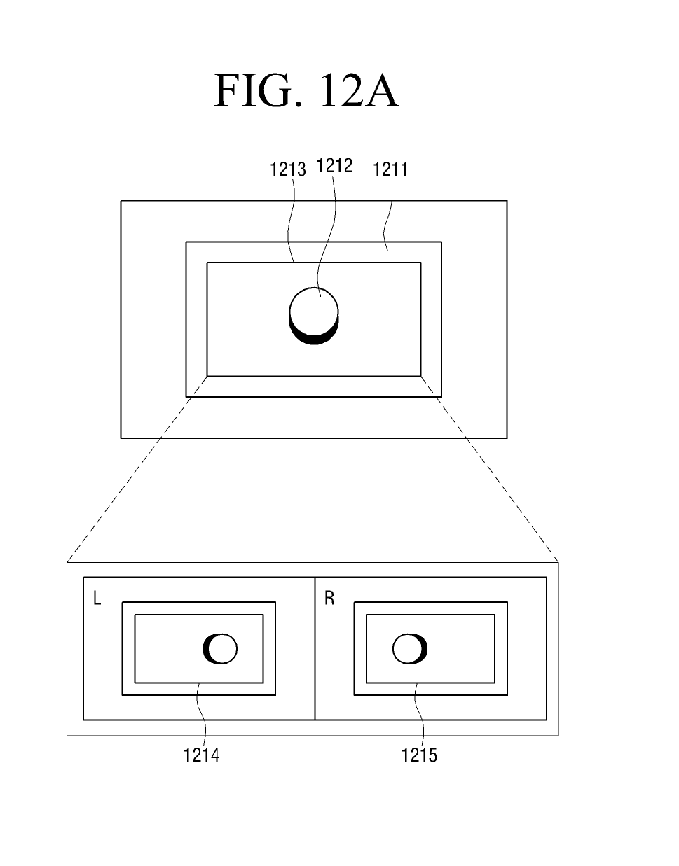

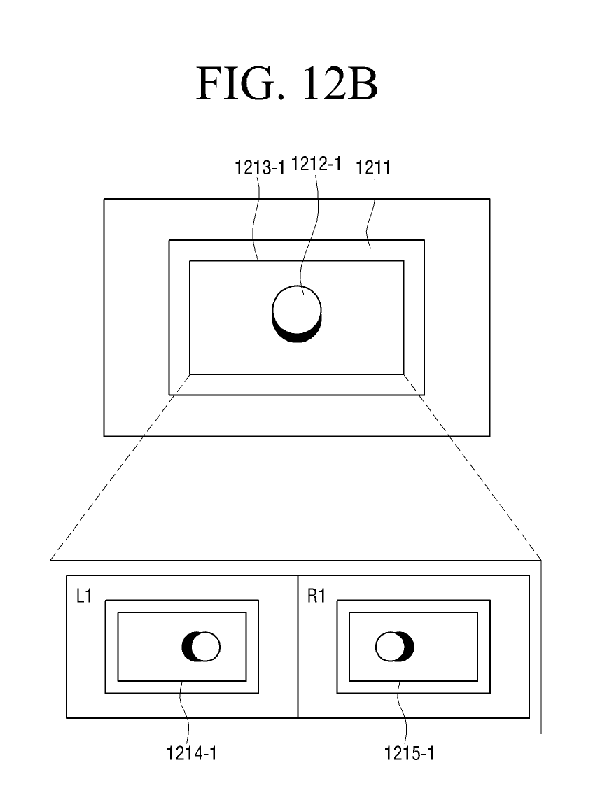

FIGS. 12A and 12B are diagrams illustrating a method of adjusting disparity information according to an embodiment of the present invention.

Referring to FIG. 12A, when content 1212 with depth or a 3D image 1213 including the content 1212 is displayed on a background UI 1211 with depth, the content 1212 or the 3D image 1213 may appear differently than intended. For example, the content 1212 or the 3D image 1213 may be displayed as recessed into the background UI 1211 or being distant from the background UI 1211.

In this example, referring to FIG. 12B, the left-eye and right-eye images 1214 and 1215 of the 3D image 1213 may be replaced with left-eye and right-eye images 1214-1 and 1215-1, respectively, which have been for adjusting disparity.

The left-eye and right-eye images 1214-1 and 1215-1 may be images that are created considering the depth of the background UI 1211 and the depth of the 3D image 1213.

For example, when the depth, on the Z-axis, of the background UI 1211, is +1 and the depth, on the Z-axis, of the 3D image 1213 is +z, the left-eye and right-eye images 1214-1 and 1215-1 may be the left-eye and right-eye images of a 3D image with a depth of (z+1).

Accordingly, when the background UI 1211, which has a depth of +1, is set as a reference surface, the left-eye and right-eye images of a 3D image 1213-1 that replaces the 3D image 1213 may appear to protrude beyond the background UI 1211 by as much as +z.

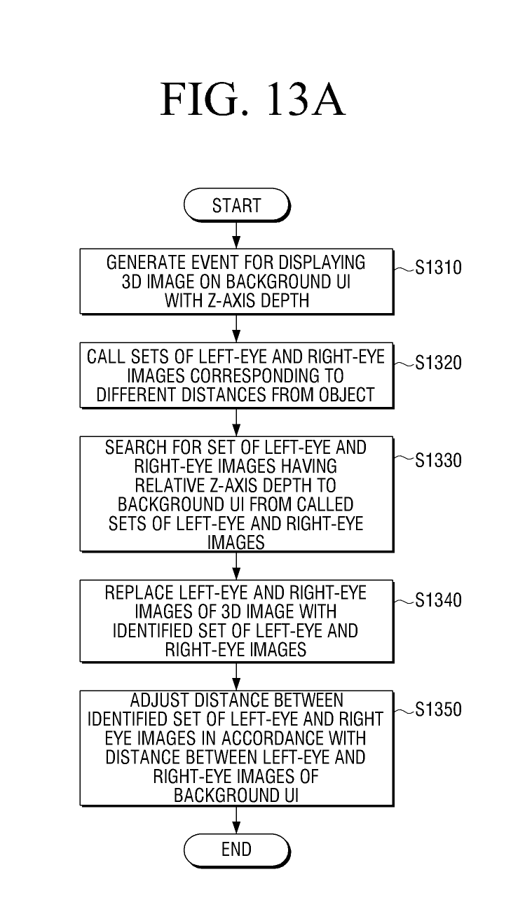

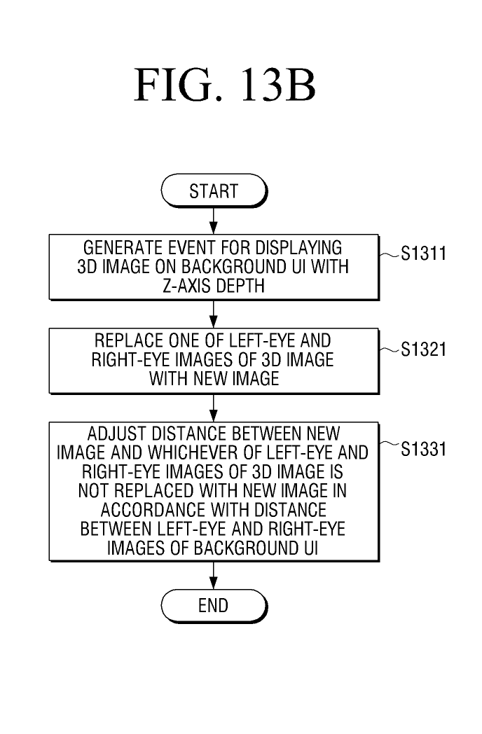

FIGS. 13A and 13B are flowcharts illustrating methods of adjusting depth according to embodiments of the present invention.

Referring to FIG. 13A, in step S1310, an event for displaying a 3D image (the current 3D image) on a background UI with a Z-axis depth value may occur. In an example, a 3D photo may be displayed over a frame with a Z-axis depth value.

In step S1320, a plurality of sets of left-eye and right-eye images of an object that correspond to different distances from the object may be called. The plurality of sets of left-eye and right-eye images may be sets of left-eye and right-eye images that are captured at different distances from the object by a 3D camera.

In step S1330, a set of left-eye and right-eye images having a relative depth, on the Z-axis, to the background UI may be searched for from the plurality of sets of left-eye and right-eye images. For example, when the Z-axis depth of the background UI is +1, a set of left-eye and right-eye images of the object that are captured at a distance of +1 may be searched for from the plurality of sets of left-eye and right-eye images. In this example, if the current 3D image has a depth of +z, a set of left-eye and right-eye images with a depth of (z+1) may be searched for from the plurality of sets of left-eye and right-eye images.

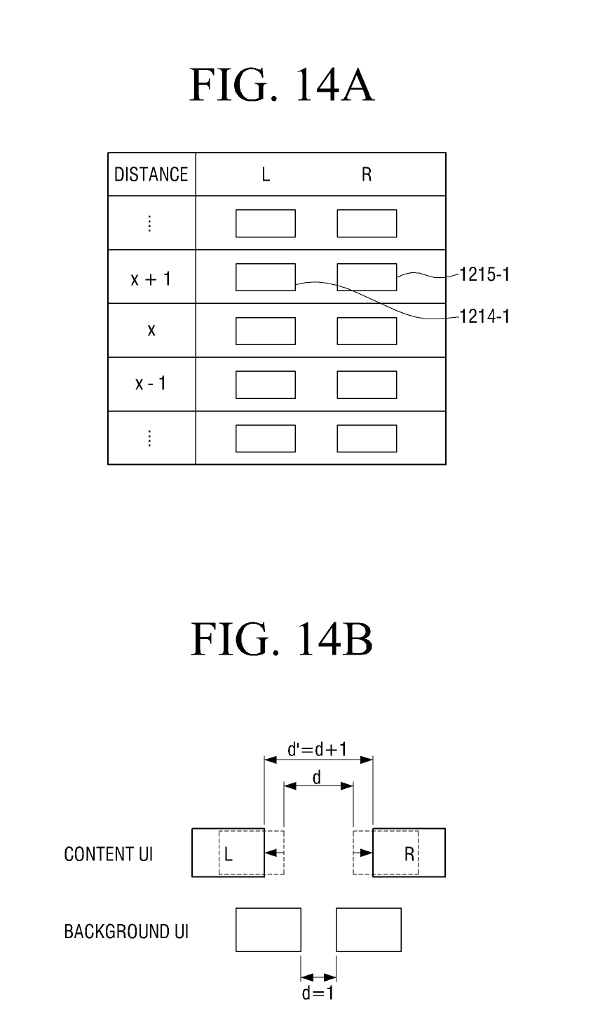

In order to accomplish the above, a plurality of left-eye and right-eye images that correspond to different imaging distances may be stored in advance, as shown in FIG. 14A.

In step S1340, the left-eye and right-eye images of the current 3D image may be replaced with the left-eye and right-eye images, respectively, that are returned in step S1330.

In step S1350, the distance on a screen between the returned left-eye and right-eye images may be adjusted in accordance with the distance between the left-eye and right-eye images of the background UI, and the distance-adjusted left-eye and right-eye images may be displayed. Accordingly, the reference surface for the returned left-eye and right-eye images may be adjusted to correspond with the background UI.

For example, referring to FIG. 14B, when the distance between the left-eye and right-eye images of the background UI is +1 and the distance between the left-eye and right-eye images of the current 3D image is +d, the distance between the returned left-eye and right-eye images is adjusted by +1 so that they are displayed a distance of (d+1) apart from each other.

Referring to FIG. 13B, in step S1321, in response to an event for displaying a 3D image (the current 3D image) on a background UI with a Z-axis depth value in step S1311, one of the left-eye and right-eye images of the current 3D image may be replaced with the other image. Accordingly, the depth of the current 3D image may be removed.

In step S1331, the distance between the replaced left-eye and right-eye images may be adjusted in accordance with the distance on a screen between the left-eye and right-eye images of the background UI, and the distance-adjusted left-eye and right-eye images may be displayed. Accordingly, the reference surface the replaced left-eye and right-eye may be adjusted to correspond with the background UI.

FIGS. 14A and 14B are diagrams illustrating methods of adjusting a set of left-eye and right-eye images and a reference surface in accordance with a previously-stored imaging distance according to embodiments of the present invention.

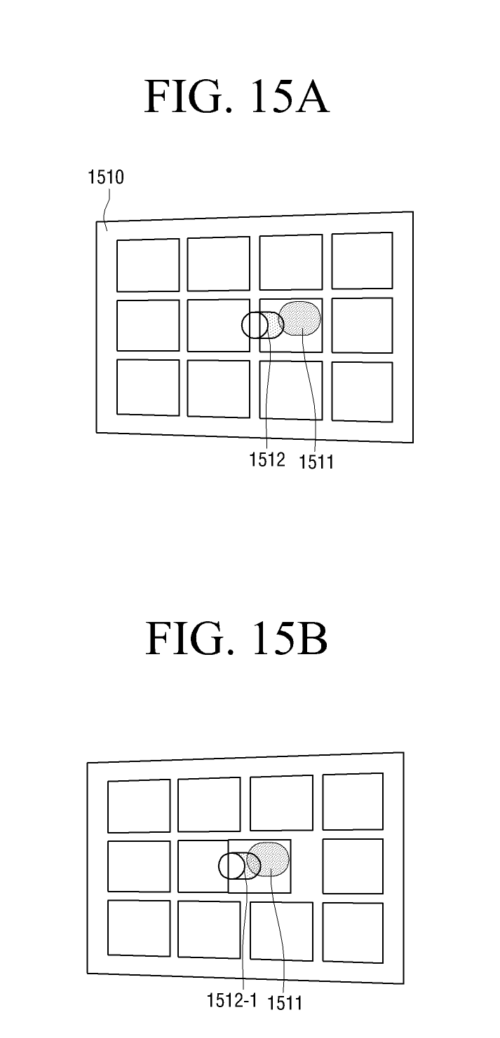

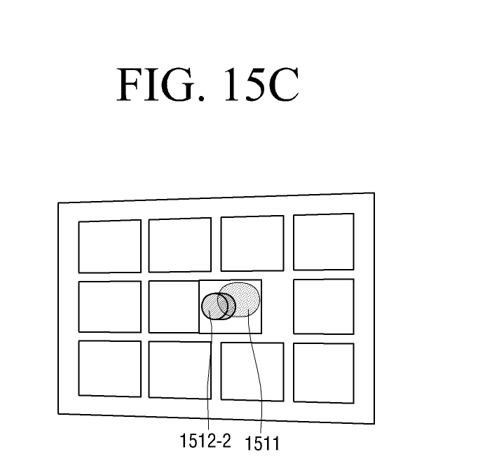

FIGS. 15A to 15C are diagrams illustrating examples to which methods of adjusting depth according to embodiments of the present invention are applied.

FIG. 15A illustrates an example in which an object 1512 with depth is displayed over a background thumbnail 1511 that is displayed with depth on a display screen 1510.

FIGS. 15B and 15C illustrate methods of adjusting depth according to embodiments of the present invention to the example illustrated in FIG. 15A.

More specifically, FIG. 15B illustrates the method illustrated in FIG. 13A being applied to the example illustrated in FIG. 15A.

Referring to FIGS. 15A and 15B, the depth of an object 1512 with respect to a background UI 1511 may be adjusted, and the depth-adjusted object 1512-1 may be displayed.

FIG. 15C illustrates the method illustrated in FIG. 13B being applied to the example illustrated in FIG. 15A.

In FIG. 15C, similar to FIG. 15B, the depth of an object 1512 with respect to a background UI 1511 may be adjusted, and the 3D depth-adjusted object 1512-2 may be displayed.

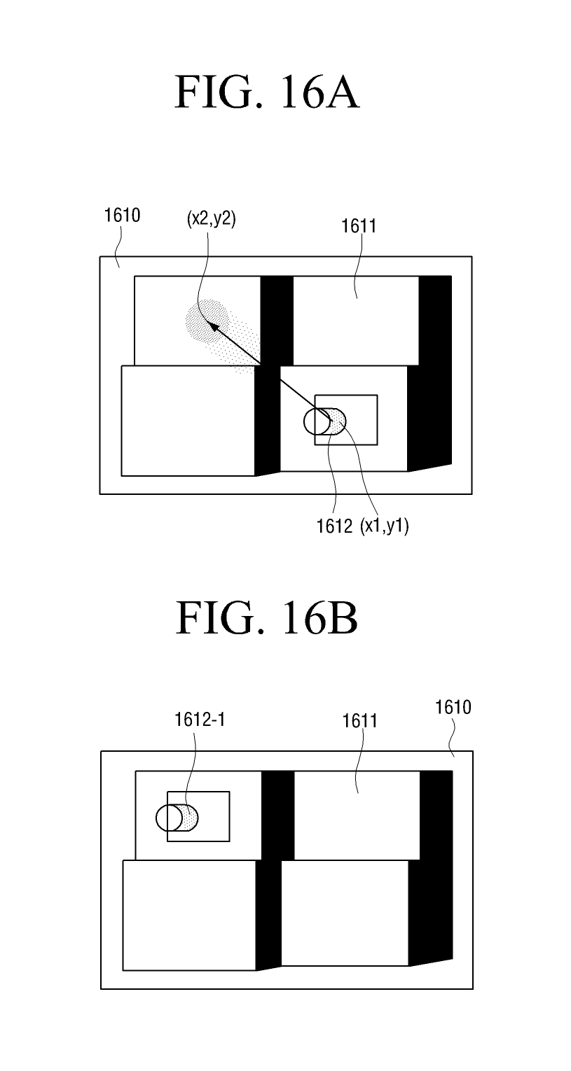

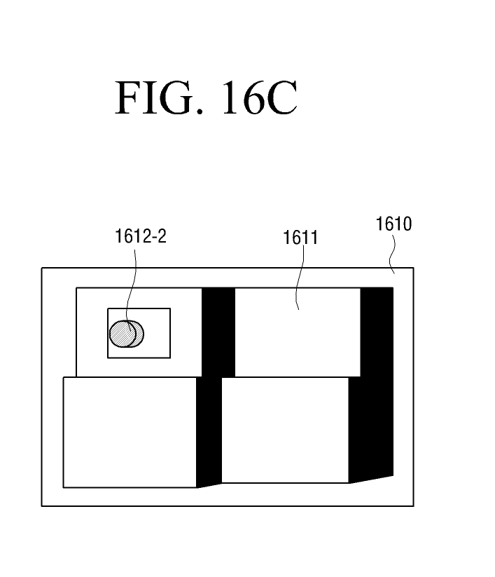

FIGS. 16A to 16C are diagrams illustrating other examples to which methods of adjusting depth according to embodiments of the present invention are applied.

FIG. 16A illustrates an example in which a background UI 1611 has different Z-axis depths from one point (x, y) to another point (x, y) on a display screen 1610 and an object 1612 with depth is displayed on the background UI 1611.

For example, referring to FIG. 16A, the object 1612 moves from a point (x1, y1) to a point (x2, y2).

FIGS. 16B and 16C illustrate methods of adjusting depth according to embodiments of the present invention to the example illustrated in FIG. 16A.

More specifically, FIG. 16B illustrates the method illustrated in FIG. 13A being applied to the example illustrated in FIG. 16A.

Referring to FIGS. 16A and 16B, the depth of an object 1612 with respect to a background UI 1611 may be adjusted, and the depth-adjusted object 1612-1 may be displayed.

FIG. 16C illustrates the method illustrated in FIG. 13B being applied to the example illustrated in FIG. 16A.

In FIG. 16C, like in FIG. 16B, the depth of an object 1612 with respect to a background UI 1511 may be adjusted, and the 3D depth-adjusted object 1612-2 may be displayed.

Further, the present invention may include a computer readable recording medium that includes a program for executing the display method of the 3D image display apparatus as described above. The computer readable recording medium includes all kinds of recording devices in which data that can be read by a computer system is stored. Examples of computer readable recording media may include, for example, a ROM, a RAM, a CD-ROM, a magnetic tape, a floppy disk, an optical data storage device, and the like. Further, the computer readable recording medium may be distributed into computer systems connected through a network, and codes, which can be read by computers in a distribution method, may be stored and executed.

Accordingly, by arranging the depth values among the 3D UI elements, the display state of the 3D UI elements can be visually stabilized.

Further, user's attention and recognition with respect to the 3D UI elements can be heightened.

Further, when a 3D image is displayed over a background UI with depth, objects in the 3D image may be displayed naturally with as much depth as the background UI.

Further, it is possible to remove the depth of a 3D image and, thus, prevent any inconsistency between disparity information of objects in the 3D image and the depth of a background UI.

While the invention has been shown and described with reference to certain embodiments thereof, it will be understood by those skilled in the art that various changes in form and detail may be made therein without departing from the spirit and scope of the invention, as defined by the appended claims and their equivalents.

What is claimed is:

1. A display method of a Three-Dimensional (3D) image display apparatus, the method comprising:
displaying a first display element having a first depth value;
adjusting at least one depth value of the first display element and a second display element having a second depth value to be displayed in superimposition with or displayed on the first display element in a state where the first display element having the first depth value is displayed; and
displaying the first display element and the second display element in superimposition with the first display element or on the first display element, of which the depth value has been adjusted,
wherein at least one of the first display element and the second display element is displayed with an adjusted depth value.

2. The display method of claim 1, wherein adjusting the at least one depth value comprises adjusting a difference in depth values between the first display element and the second display element in consideration of respective depth values of the first display element and the second display element.

3. The display method of claim 1, wherein adjusting the at least one depth value comprises changing the second depth value of the second display element to a preset depth value, and changing the first depth value of the first display element to the depth value to which the second display element has been changed.

4. The display method of claim 3, wherein the preset depth value is smaller than the second depth value of the second display element.

5. The display method of claim 3, wherein the preset depth value includes a depth value of a display screen.

6. The display method of claim 1, further comprising:
displaying a third display element having a third depth value before displaying the second display element;
adjusting the third depth value of the third display element to a same depth value as the first display element, when the second display element is to be displayed in superimposition with the first display element and the third display element.

7. The display method of claim 6, wherein the same depth value of the first and third display elements is smaller than the second depth value of the second display element.

8. The display method of claim 1, further comprising:
adjusting the adjusted depth value of the first and second display elements to original depth values if the superimposition display of the first and second display elements is canceled.

9. The display method of claim 1, wherein the second display element includes a display element having a feedback property that includes event contents related to the first display element, and a display element having at least one property of an alarm, a caution, and a popup that includes event contents that are not related to the first display element.

10. The display method of claim 1, wherein the first depth value corresponds to a disparity between left-eye and right-eye images of the first display element and the second depth value corresponds to a disparity between left-eye and right-eye images of the second display element.

11. The display method of claim 1, wherein adjusting the at least one depth value comprises:
calculating a value of a relative depth of the second display element to the first display element;
detecting a set of left-eye and right-eye images that correspond to the calculated value of relative depth from among a plurality of sets of previously-stored sets of left-eye and right-eye images that correspond to different depth values; and
replacing left-eye and right-eye images of the second display element with the detected set of left-eye and right-eye images, respectively.

12. The display method of claim 1, wherein adjusting the at least one depth value comprises:
replacing one of left-eye and right-eye images of the second display element with the other image.

13. The display method of claim 11, further comprising:
adjusting a distance between the detected left-eye and right-eye images in accordance with a distance between left-eye and right-eye images of the first display element and displaying the distance-adjusted left-eye and right-eye images.

14. The display method of claim 12, further comprising:
adjusting a distance between the replaced left-eye and right-eye images in accordance with a distance between left-eye and right-eye images of the first display element and displaying the distance-adjusted left-eye and right-eye images.

15. The display method of claim 11, wherein the first display element is a background element and the second display element is a content element on the background element.

16. The display method of claim 12, wherein the first display element includes a background element and the second display element includes a content element on the background element.

17. A Three-Dimensional (3D) image display apparatus, the apparatus comprising:
a display processing unit for generating a first display element having a first depth value and a second display element having a second depth value;
a display unit for displaying the generated first and second display elements; and
a control unit for adjusting and displaying at least one depth value of the first display element and the second display element having the second depth value to be displayed in superimposition with or displayed on the first display element in a state where the first display element having the first depth value is displayed,
wherein at least one of the first display element and the second display element is displayed with an adjusted depth value.

18. The 3D image display apparatus of claim 17, wherein the control unit adjusts a difference in depth values between the first display element and the second display element in consideration of respective depth values of the first display element and the second display element.

19. The 3D image display apparatus of claim 17, wherein the control unit changes the second depth value of the second display element to a preset depth value, and changes the first depth value of the first display element to the depth value to which the second display element has been changed.

20. The 3D image display apparatus of claim 19, wherein the preset depth value is smaller than the second depth value of the second display element.

21. The 3D image display apparatus of claim 19, wherein the preset depth value includes a depth value of a display screen.

22. The 3D image display apparatus of claim 17, wherein the display unit displays a third display element having a third depth value before displaying the second display element, and
the control unit adjusts the first and third depth values of the first and third display elements to the same depth value, when the second display element having the second depth value is displayed in superimposition with the first display element and the third display element.

23. The 3D image display apparatus of claim 22, wherein the same depth value of the first and third display elements is smaller than the second depth value of the second display element.

24. The 3D image display apparatus of claim 17, wherein the control unit adjusts the adjusted depth value of the first and second display elements to the original depth values, if the superimposition display of the first and second display elements is canceled.

25. The 3D image display apparatus of claim 17, wherein the second display element is a display element having a feedback property that includes event contents related to the first display element, and a display element having at least one property of an alarm, a caution, and a popup that include event contents that are not related to the first display element.

26. The 3D image display apparatus of claim 17, wherein the first depth value corresponds to a disparity between left-eye and right-eye images of the first display element and the second depth value corresponds to a disparity between left-eye and right-eye images of the second display element.

27. The 3D image display apparatus of claim 17, wherein the control unit calculates a value of the relative depth of the second display element to the first display element, detects a set of left-eye and right-eye images that correspond to the calculated relative depth value from among a plurality of sets of previously-stored sets of left-eye and right-eye images that correspond to different depth values, and replaces left-eye and right-eye images of the second display element with the detected left-eye and right-eye images, respectively.

28. The 3D image display apparatus of claim 17, wherein the control unit replaces one of left-eye and right-eye images of the second display element with the other image.

29. The 3D image display apparatus of claim 27, wherein the control unit adjusts a distance between the detected left-eye and right-eye images in accordance with a distance between left-eye and right-eye images of the first display element and displays the distance-adjusted left-eye and right-eye images.

30. The 3D image display apparatus of claim 28, wherein the control unit adjusts a distance between the replaced left-eye and right-eye images in accordance with a distance between left-eye and right-eye images of the first display element and displays the distance-adjusted left-eye and right-eye images.

31. The 3D image display apparatus of claim 27, wherein the first display element is a background element and the second display element is a content element on the background element.

32. The 3D image display apparatus of claim 28, wherein the first display element is a background element and the second display element is a content element on the background element.
